(19) United States
(12) Patent Application Publication
(10) Pub. No.: US 2010/0327243 A1
(43) Pub. Date: Dec. 30, 2010

(54) WOVEN STRUCTURE AND PANEL OR CONTAINER COMPRISING SUCH A STRUCTURE

(75) Inventor: Georges-Paul Deschamps, Voeuil Et Giget (FR)

Correspondence Address: YOUNG & THOMPSON, 209 Madison Street, Suite 500, Alexandria, VA, 22314, US

(73) Assignee: ETS A. DESCHAMPS ET FILS, La Couronne (FR)

(21) Appl. No.: 12/864,990

(22) PCT Filed: Jan. 29, 2009
(86) PCT No.: PCT/EP09/50938

§ 371 Date: Sep. 16, 2010

(30) Foreign Application Priority Data
Jan. 29, 2008 (FR) 0850541

(51) Int. Cl. B66F 3/35; D03D 11/00; D03D 25/00; D03D 1/02

(52) U.S. Cl. 254/93 HP; 442/239; 442/246; 442/243; 428/35.2; 428/221

(57) ABSTRACT

A woven structure includes at least two woven walls (11, 12) connected to one another by at least one unattached binding thread (13). The variation of the length between two consecutive sinkers of the at least one binding thread (13), each of the sinkers corresponding to a riser by a weft thread of a different wall (11, 12), is continuous on at least one portion of the structure in the direction of the warp and/or in the direction of the weft. This structure can be applied to the fields of aviation, shipping, household furnishings, and automobiles.

This invention relates to a woven structure and a part equipped with such a structure. It relates more specifically to a flexible container comprising such a structure and forming an inflatable reservoir.

Inflatable cushions for lifting aircraft are known that are designed to facilitate the towing from the mud and the recovery of commercial and military aircraft that have accidentally veered off the runway.

These cushions allow the airport emergency crews confronted with an aircraft off the runway to lift the latter and then to tow it quickly and safely, while avoiding causing any secondary damage to it.

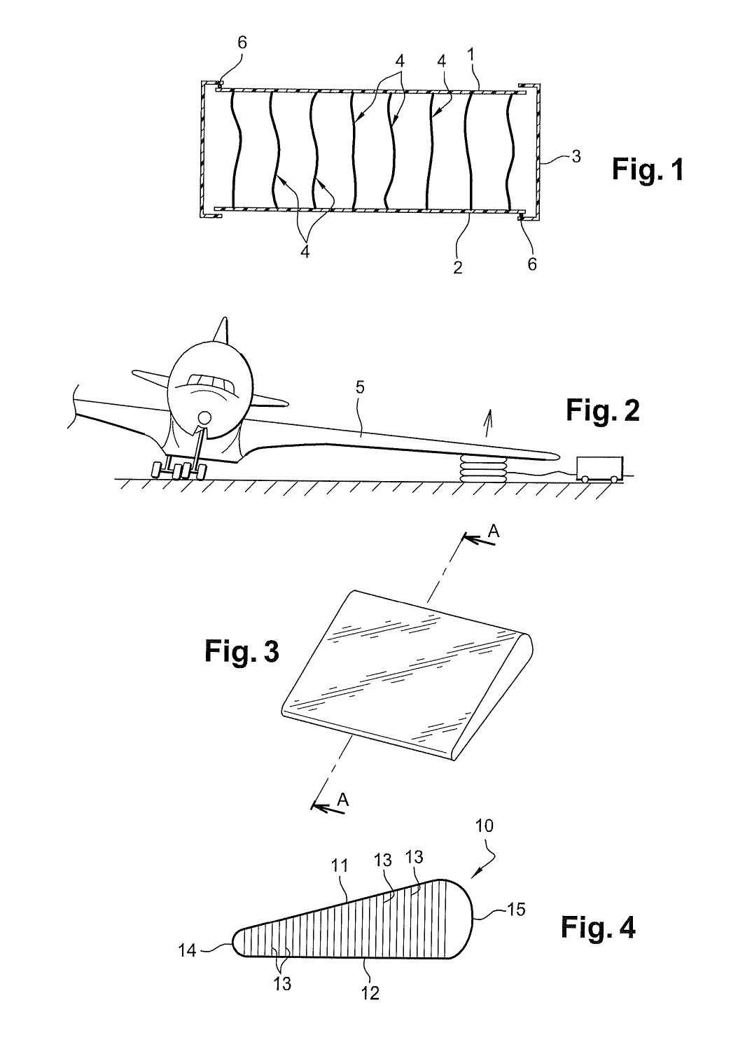

FIG. 1 is a cutaway view of an aircraft lifting cushion of the prior art. This cushion typically comprises two woven walls 1, 2 coated for sealing and hot-vulcanized. These woven walls 1, 2 are connected on their periphery by excess rubber thickness 3.

These walls 1, 2 are also connected to one another by polyamide threads 4, which, when they are put under tension by inflation of the cushion, are parallel and evenly spaced from one another.

These threads 4 are of an identical length so as to keep the walls 1, 2 parallel. The application of a uniform lifting pressure on the structure of the aircraft under which this cushion is placed is thus ensured.

This latter point is especially critical, for example during the lifting of fragile elements such as an aircraft wing 5, to avoid the onset of structural damage to the latter (FIG. 2).

Now, losses of air from these lifting cushions can be observed that result from a manufacturing defect or that appear over time at rupture points 6 of the structure of the lifting cushion. By way of illustration, the manufacturing defects can result from poor vulcanization or else from a slipping of the excess rubber thickness 3 before vulcanization.

Such defects lead to a non-uniform application of the lifting force on the structure of the aircraft and may be responsible for secondary damage.

There is thus a critical need for an inflating cushion that is produced in a single piece to provide increased resistance to stress.

More generally, numerous woven articles that exhibit a complex shape such as cushions filled with polystyrene pellets, chair slipcovers, etc., . . . , result from the assembly of initially separate textile pieces that are then joined, for example, by stitching to impart its definitive shape to the article.

Now, these articles by definition exhibit a certain structural weakness at these assembly areas.

Premature wear of the article at these areas can result in, for example, the loss of the filling material of the article.

Finally, the assembly time for these articles that have a complex shape can be relatively long and require skilled operators, making the article expensive.

The object of this invention is therefore to propose a textile piece that is simple in its design and its operating method, all in one piece thus imparting to it mechanical properties that are superior to the known articles of the prior art obtained by the assembly of initially separate elements by stitching, gluing, . . . , or else by a combination of these methods of assembly.

Another object of the invention is a woven structure all in one piece that has a complex shape such as a conical or cylindrical shape, exhibiting an increased mechanical strength for the making of composite parts such as radomes, aircraft fuselage sections, ship hulls or else furniture.

For this purpose, the invention relates to a woven structure comprising at least two woven walls connected to one another by at least one unattached binding thread.

According to the invention, the variation of the length between two consecutive sinkers of said at least one binding thread, each of said sinkers corresponding to a riser by a weft thread of a different wall, is continuous on at least one portion of the structure in the direction of the warp and/or in the direction of the weft.

Each of these two sinkers belongs to the basic weave of a wall or different layer. In other words, since each of these two sinkers corresponds to a riser, or binding thread connected by a weft thread of a different wall, these walls are connected to each other by the binding thread. The linking between the two woven walls is therefore ensured by additional warp threads.

This woven structure can be closed or at least partially open. This opening can be placed at any point in the woven structure, i.e., at at least one of its ends, the corresponding edges of these walls then not being connected to one another, or else can result from the presence of an opening on at least one of the walls.

The cross-section of this woven structure can advantageously exhibit any shape, such as a circular-, square-, rectangular-, diamond-, T-, U-, L-, H-, I-, . . . -shape, after possible cutting of the unnecessary warp threads.

“Continuous variation” is defined as this variation is uniform and does not exhibit jumps or plateaus.

“Unattached binding thread” is defined as this thread is not attached after weaving of each of these walls for their assembly, but on the contrary, it is inserted into the weft of these woven walls as they are manufactured.

The binding thread is therefore an integral part of the weave of the two walls on portions of them.

The woven structure thus obtained is all in one piece, which imparts an increased mechanical resistance to constraints.

This woven structure can be of a single piece or, in contrast, comprise different materials.

The expression “the woven structure is all in one piece” is defined as this structure consists of a single piece and is made from a single material. The warp threads or weft threads used can, however, have a different shape, i.e., be of monofilament thread, multifilament thread, flat thread, thread made of twisted fibers, single or rotor thread, for example, and can exhibit different thicknesses or diameters.

These threads can be, for example, cotton threads, polyester threads; threads of polyamide, polypropylene, polyethylene; threads of starch-based biodegradable plastic materials, of oxo-degradable plastic materials; threads made of fibers of carbon, graphite, glass, silica, aramid, . . . .

Moreover, the walls can have different dimensions and/or different shapes as a function of the application envisaged for the woven structure.

Thus, and purely by way of illustration, for the purpose of the manufacture of an aircraft wing exhibiting a symmetrical double-convex profile, a woven structure will be able to be used comprising an upper convex wall, a plane intermediate wall, and a lower wall that is convex and symmetrical with the upper wall in relation to the intermediate wall. To obtain a wing exhibiting a convex plane profile, these same walls will exhibit respectively a convex portion to form a convex upper surface, with a single curvature, and a plane portion to form a flat lower surface. Of course, these walls are connected at their ends to form the leading edge and the trailing edge of the wing. The density of the binding threads and their composition ensure, once the structure hardens, the support of the upper and lower walls and the mechanical rigidity necessary for the wing for the uptake of stresses.

Advantageously, this structure comprises an upper wall, an intermediate wall, and a lower wall, these walls being superposed, at least a first binding thread connecting said upper and intermediate walls, and at least a second binding thread connecting said lower and intermediate walls, at least one of these first and second binding threads exhibiting a variation of length between two consecutive sinkers, each of said sinkers corresponding to a riser by a weft thread of a different wall, which is continuous on at least one portion of the structure in the direction of the warp and/or in the direction of the weft.

The invention also relates to a woven structure comprising at least an upper woven wall and a lower woven wall, which are connected to one another by at least one unattached binding thread.

According to the invention, said at least one binding thread exhibiting several portions floating in the direction of the weft, each of these portions corresponding to said at least one binding thread connected, on the one hand, by at least two warp threads of the upper wall and, on the other hand, by at least two warp threads of the lower wall, the variation of the length of said floating portions is continuous on at least one portion of said woven structure in the direction of the weft and/or of the warp.

The linking between the two woven walls is therefore obtained from additional filling picks and not from additional warp threads as described previously.

In different particular embodiments of this woven structure, each having its particular advantages and capable of numerous possible technical combinations:

the binding threads being under tension, at least a majority of the lengths between two consecutive sinkers of these binding threads are rectilinear while being evenly spaced or not,

the walls and/or the binding threads are made of different materials.

The binding threads can advantageously be made of different materials in such a way that the woven structure exhibits areas of different mechanical strength.

Purely by way of illustration, there can thus be generated a marking area in the woven structure with binding threads exhibiting a weaker mechanical strength than the other binding threads of the structure, and therefore a lower breaking threshold than that of the other binding threads.

The application of a pressure greater than a recommended maximum pressure threshold, during the inflation of a flexible lifting reservoir manufactured from this woven structure, can cause the breaking of these binding threads that have a weaker strength that allows the operator to directly observe that this pressure threshold has been crossed and that he must intervene to stop the inflation of the reservoir.

This marking area thus offers a simple and effective safety and control means to ensure that no secondary damage can be caused to a structural element of an aircraft off the runway during its lifting.

These walls may or may not be continuous.

Purely by way of illustration, at least one of these walls can comprise an opening. The woven structure can thus comprise an opening and form a ring.

The length of the warp threads and/or of the weft threads of at least one of these walls is different from the length of the warp threads and/or of the weft threads, respectively, of the other walls.

This could be achieved, for example, when the walls exhibit different weaves. These walls can have a weaving of plain weave or twill weave for a base.

One of the walls intended to be in contact with the ground can also exhibit a surface relief comprising peaks and hollows to impart to it an adherence to the ground.

Alternatively, a first wall can exhibit a surface relief composed of hollows while a second wall of the woven structure comprises peaks intended to work with the hollows of the first wall so as to prevent a possible slipping of one structure in relation to another when these are stacked on one another.

These peaks and hollows can be, respectively, male and female indentations. By way of illustration, these indentations can result in a honeycomb weave.

More generally, since the walls have an identical weave, the lengths of the warp threads and/or weft threads can be different, one of these walls being longer.

The woven structure comprising at least one lateral wall connecting these walls, at least some of these warp threads and/or weft threads are placed both in at least one of these walls and in said lateral wall, said threads being continuous.

In this particular embodiment, the woven structure is at least partially closed. The continuity of the warp threads and/or weft threads on all or part of the upper, lower and lateral walls ensures a superior mechanical strength of the woven structure.

The density of binding threads is greater than 1 thread/10 cm².

This binding thread density, however, depends on the applications envisaged for the woven structure. This binding thread density can therefore vary from one thread/10 cm² to several hundred threads/cm².

The binding threads are flexible.

By way of illustration, these binding threads are selected from the group comprising monofilament threads, multifilament threads, single or rotor thread, threads comprising agglomerated fibers, flat threads, flexible metallic threads, sheathed threads, i.e., each comprising a core thread and a sheath made of thermoplastic material, and combinations of these elements.

“Flat thread” is defined as a product extruded through a die, drawn out or the like, whose cross-section that is full and approximately constant over its entire length is in the shape of an oval, square, rectangle, flattened circle, or modified square or rectangle, i.e., having two opposite sides that have a convex arc shape, the other two being rectilinear, equal and parallel.

These flat threads could also be hollow and exhibit, by way of illustration, a flattened tubular section.

The invention also relates to a flexible container. According to the invention, this reservoir comprises a structure as described previously.

Preferably, this structure is sealed. For this purpose, the walls may have been coated with a sealing material such as a material having a polyvinyl chloride (PVC) or polyurethane base, and even better a material having a flame-retardant plasticized PVC base.

Since it is a matter of an inflatable cushion that can be used, for example, for the lifting of an aircraft off a runway, the container will comprise a selvage, an area intended to form a rounding when the container is under pressure, and a plane central area. Moreover, it can comprise handles to allow the movement of this cushion.

The invention also relates to a panel comprising at least two walls spaced from one another.

According to the invention, these two walls are formed by a structure as described previously.

The entire structure can be embedded in a hardened resin. Alternatively, the binding threads and the constituent threads of the walls having been pre-impregnated, the woven structure is polymerized.

For example, these threads can be pre-impregnated with a thermosetting or thermoplastic resin, and particularly a thermostable thermoplastic resin such as that of the families of polyether imides (PEI), polyether ether ketones (PEEK) or polyamides (PA).

The polymerization operations are well known processes of the prior art that will not be described again here. Purely by way of illustration, simply the resin transfer molding (RTM) process or else the liquid resin infusion (LRI) molding process will be cited.

Of course, the floating portions of the rectilinear binding threads will be sought to be maintained during polymerization. For this purpose, compressing the woven structure during its impregnation stage with a resin will be avoided.

The panel of this invention advantageously exhibits good mechanical properties in the plane of each wall, but also in a direction perpendicular to these walls because of the binding threads that connect these walls.

The invention relates to a ship equipped with at least one panel as described previously.

The invention relates to an aircraft equipped with at least one panel as described previously. Said at least one panel can be part of the fuselage of the aircraft or of the radome.

The invention also relates to an interior or exterior household article such as a chair filled with polystyrene pellets, furniture, a quilt filled with foam or with down, . . . .

According to the invention, this household article comprises a structure as described previously.

More generally, the invention relates to any manufactured article equipped with a structure as described previously.

The invention will be described in more detail in reference to the accompanying drawings in which:

FIG. 1 is a cutaway view of a lifting cushion of the prior art;

FIG. 2 shows a stack of lifting cushions of FIG. 1 placed under a wing of an aircraft off a runway for the purpose of lifting it;

FIG. 3 shows in perspective a panel according to a preferred embodiment of the invention;

FIG. 4 is a cutaway view along axis A-A of the woven structure used for the manufacture of the panel of FIG. 3;

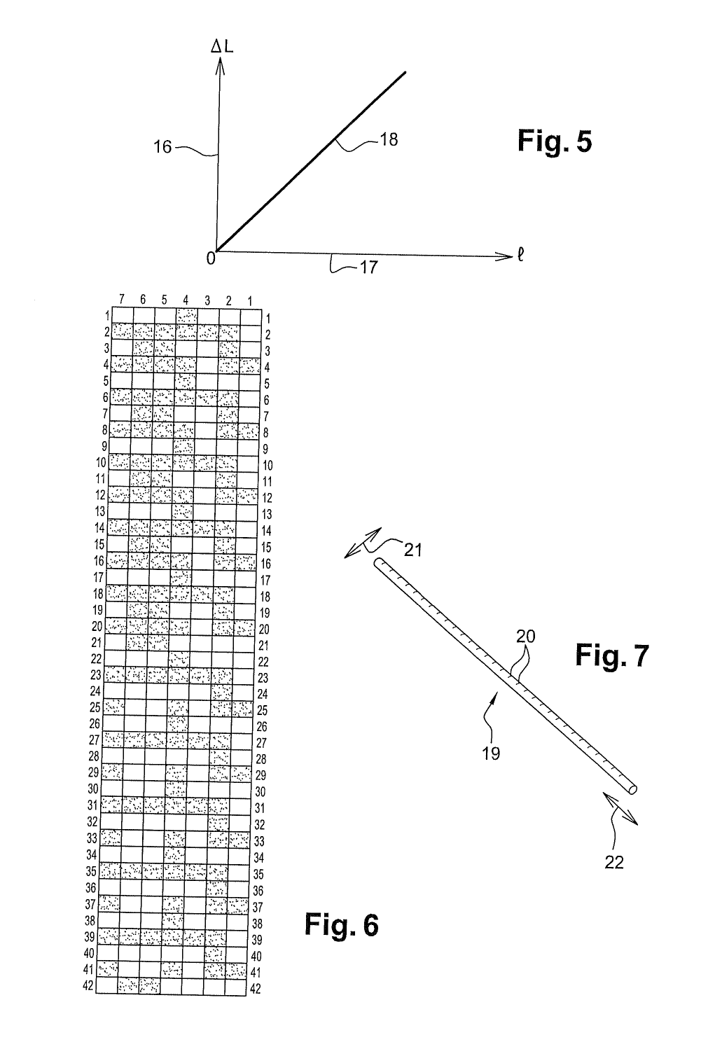

FIG. 5 is a schematic representation of the variation of the length between two consecutive sinkers of a binding thread of the woven structure of FIG. 4 in the direction of the warp;

FIG. 6 schematically shows the weave of the woven structure of FIG. 4;

FIG. 7 schematically shows a temple used in the manufacture of the woven structure of FIG. 4.

FIG. 3 shows a perspective view of a panel according to a preferred embodiment of the invention. This panel consists of a woven structure 10 embedded in a hardened coating of a thermosetting resin such as an epoxide resin.

FIG. 4 is a cutaway view of the woven structure 10 that has been used in the manufacture of the panel of FIG. 3. Woven structure 10 is of a single piece and is made from threads made of carbon fibers.

This woven structure 10 comprises two woven walls 11, 12 that are connected to one another by unattached binding threads 13. The upper wall 11 is inclined and forms an angle in relation to the lower wall 12, which is horizontal.

These two walls 11, 12 are continuous and plane. They are connected at each of their ends by a woven part 14, 15 intended to exhibit a rounded or approximately rounded shape after polymerization, so that the panel forms a closed object.

These two walls 11, 12 exhibit a 1 to 1 plain weave with a number of warp threads greater than 10 threads/cm and a number of weft threads greater than 6 threads/cm so as to ensure a good tightening of the woven structure.

FIG. 5 shows the variation of the length (Y axis, 16) of a binding thread between two consecutive sinkers in the direction of the warp, which here is in the length of the panel (X axis, 17).

Since each of these two sinkers corresponds to a riser, or binding thread connected by a weft thread of a different wall, these walls are connected to one another. Between these two consecutive sinkers, the corresponding binding thread 13 is floating, i.e., it exhibits a floating thread portion.

This variation of length (ΔL) in the direction of the warp is therefore calculated by taking the difference between the lengths of two floating portions of the same binding thread following itself immediately in the direction of the warp.

It is evident from FIG. 5 that the variation of length of a binding thread 13 between two consecutive sinkers, in the direction of the warp of the woven structure, follows a straight line 18. This variation is consequently gradual, i.e., continuous and regular.

More generally, what has just been shown in the case of an additional warp thread, which is a binding thread, could be applied to an additional weft thread. Likewise, since the woven structure has several binding threads in the direction of the warp or of the weft, the continuous variation of the lengths of the successive floating portions in a given direction could be shown, each of these portions belonging to a different binding thread. These directions could be those of the weft, of the warp, or along a diagonal. In this latter case, the floating portions could be offset in relation to one another, for example, in staggered arrangement.

This woven structure has been obtained according to the manufacturing process described below.

The walls are begun to be woven simultaneously by weaving an upper layer 11 and a lower layer 12 following the basic weave of each of these walls, the binding thread 13 being solely connected to the basic weave of the upper layer 11. At the time of connecting these two walls by said at least one binding thread 13, i.e., before connecting the binding thread in the lower layer, the weaving is interrupted, and a rod 19 known as a temple is inserted into the weaving area to draw only said at least one binding thread 13. The length of the binding thread thus drawn is placed above upper layer 11.

Of course, it would be possible to proceed symmetrically and to draw the binding thread under the lower layer after having inserted it in this layer and before connecting it to the basic weave of the upper layer.

In FIG. 4, it can be observed that row 21 of the weave corresponds schematically to the replacing of a filling pick, that is to say a weaving phase, by the insertion into the weaving area of the temple to draw the binding threads numbered 5 and 6, each opposite a vertical column. The numbered warp threads 1 and 3 correspond to the warp threads of the lower layer, and the numbered warp threads 2 and 4 correspond to the warp threads of the upper layer.

This thus drawn length of the binding thread as well as the distance separating the upper and lower layers corresponds to the distance separating the walls of the final woven structure at this linking of the walls by said at least one binding thread.

Once the binding thread is drawn to the appropriate length, the temple is brought out of the weaving area and the manufacture of the woven walls is normally resumed until the next linking of the walls by this binding thread.

These binding threads 13 are therefore drawn above (or symmetrically, below) the two layers that form the upper wall 11 and the lower wall 12 of the woven structure, and they are therefore placed in part outside of the woven structure.

These binding threads 13 are then redrawn into the woven structure while separating the layers from one another.

On one of its edges, rod 19 advantageously exhibits a rough surface or a network of vertical grooves 20 each intended to receive a binding thread so that the binding threads cannot slip on the surface of the rod 19 during the drawing step of said at least one binding thread. Moreover, it is advantageously mobile in translation in a horizontal plane 21, 22.

Since walls 11, 12 are plane here, rod 19 has a uniform diameter and does not exhibit surface relief (FIG. 7). When it is desired to give a particular shape to one of the walls of the woven structure, the rod will have a surface relief on the edge comprising the rough surface or the network of grooves, this relief constituting an impression of the relief to impart to the wall at the site of the thus drawn binding threads. Of course, it will be necessary to change the temple between the drawing steps of the binding threads to construct—during the weaving of the woven structure—the definitive shape of this wall.

More generally, the invention relates to a weaving process of at least two layers connected to one another by at least one binding thread. According to the invention,

a) the weaving of these layers is initiated by inserting into the basic weave of a first layer at least one warp thread or additional filling pick, one of the latter constituting said binding thread,

b) before insertion of said at least one binding thread into the basic weave of the second layer, the weaving of these layers is suspended,

c) said at least one binding thread is drawn from the side of the second layer while placing at least one portion of the drawn length outside of the assembly formed by these thus connected layers,

d) then, the weaving of the layers is resumed by inserting said at least one binding thread into the basic weave of the second layer,
before each new insertion of said at least one binding thread into the basic weave of one of these layers, the following cycle is repeated:

e) the weaving of the layers is suspended,

f) said at least one binding thread is drawn while placing at least one portion of the drawn length outside of the assembly formed by these thus connected layers, this thus drawn length being able to be placed above or below,

g) then, the weaving of the layers is resumed by inserting said at least one binding thread into the basic weave of said layer.

The drawing of said at least one binding thread is achieved with a gripping element, which can be a temple as described previously or a set of needles provided with a hook on their ends, each of these needles making it possible to draw a single binding thread. These needles are activated by electromagnets or a hydraulic or pneumatic piston. In addition, they are suitable for a movement in translation.

The process of the invention can be applied to the production of composite pieces of sheet metals as well as structural pieces falling within the production of aircraft, for example fuselages or fuselage parts such as the wings of an aircraft or the radome. It is also possible to make jet tanks or reservoir skirts.

Maritime applications can be envisaged, by way of illustration, the production of boat hulls, container bodies, floats, . . . .

1. Woven structure comprising at least two woven walls (11, 12) connected to one another by at least one unattached binding thread (13), characterized in that the variation of the length between two consecutive sinkers of said at least one binding thread (13), each of said sinkers corresponding to a riser by a weft thread of a different wall, is continuous on at least one portion of said structure in the direction of the warp and/or in the direction of the weft.

2. Structure according to claim 1, wherein it comprises an upper wall (11), an intermediate wall, and a lower wall (12), said walls being superposed, at least a first binding thread connecting said upper and intermediate walls, and at least a second binding thread connecting said lower and intermediate walls, at least one of said first and second binding threads exhibiting a variation of length between two consecutive sinkers, each of said sinkers corresponding to a riser by a weft thread of a different wall, which is continuous on at least one portion of said structure in the direction of the warp and/or in the direction of the weft.

3. Woven structure that comprises at least one upper woven wall (11) and one lower woven wall (12) that are connected to one another by at least one unattached binding thread (13), wherein said at least one binding thread (13) has several portions floating in the direction of the weft, each of these portions corresponding to said at least one binding thread (13) connected by, on the one hand, at least two warp threads of the upper wall and by, on the other hand, at least two warp threads of the lower wall, the variation of the length of said floating portions is continuous on at least one portion of said woven structure in the direction of the weft and/or of the warp.

4. Structure according to claim 1, wherein said binding threads (13) being under tension, at least a majority of the lengths between two consecutive sinkers of said binding threads (13) are rectilinear while being evenly spaced or not.

5. Structure according to claim 1, wherein the length of the warp threads and/or of the weft threads of at least one of said walls (11, 12) is different from the length of the warp threads and/or the weft threads of the other walls (11, 12).

6. Structure according to claim 5, wherein said walls (11, 12) have different weaves.

7. Structure according to claim 1, wherein said walls (11, 12) may or may not be continuous.

8. Structure according to claim 1, wherein said structure is of a single piece.

9. Structure according to claim 1, wherein said walls (11, 12) and/or said binding threads (13) are produced in different materials.

10. Structure according to claim 1, wherein said binding threads (13) are selected from the group that comprises monofilament threads, multifilament threads, threads comprising agglomerated fibers, flat threads, flexible metallic threads, and combinations of these elements.

11. Structure according to claim 1, wherein said woven structure comprises at least one lateral wall (14, 15) connecting said walls (11, 12), at least some of said warp threads and/or weft threads are placed both in at least one of said walls (11, 12) and in said lateral wall (14, 15), said threads being continuous.

12. Flexible container, wherein it comprises a structure according to claim 1.

13. Container according to claim 12, wherein said structure is more airtight.

14. Container according to claim 13, wherein it comprises a selvage, an area intended to form a rounding when the container is under pressure, and a plane central area for forming an inflatable cushion.

15. Panel that comprises at least two walls that are spaced from one another, wherein said two walls (11, 12) are formed by a structure according to claim 1.

16. Ship equipped with at least one panel according to claim 15.

17. Aircraft equipped with at least one panel according to claim 15.

18. Interior or exterior household article, wherein it comprises a structure according to claim 1.
